(19) United States
(12) Patent Application Publication
(10) Pub. No.: US 2007/0147930 A1
(43) Pub. Date: Jun. 28, 2007

(54) Light guides to assist in movement of a handheld printing device

(76) Inventors: Sogra Nishath, Georgetown, KY (US); Brandon Satanek, Stevensville, MI (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/319,008

(22) Filed: Dec. 27, 2005

(51) Int. Cl. B41J 3/36

(52) U.S. Cl. 400/88

(57) ABSTRACT

A printing device includes light guides to assist the user in aligning the device with a reference, such as the edge of a page. The light guides emit a beam of light that produces an illuminated visible straight line segment on the page. The light guides can employ a light source such as an LED, an incandescent bulb, or a laser, and they can use a divergent lens to spread the light into a straight line segment that is projected onto the page.

### BACKGROUND OF THE INVENTION

This invention relates to handheld printing devices, and specifically to light guides to assist in movement of a handheld printing device.

Handheld printers are a relatively recent development with a wide range of applicable uses. In particular, printing border effects across the edges of paper has been investigated as well as printing web pages from mobile (telephone) devices. To operate the printer, the user is typically required to manually move the printer across a sheet of paper. While the printer is in motion, and while it is in an active print mode (often achieved by pressing a button), the handheld printer will print. The printing can be accomplished using a print engine implemented in a manner known to persons skilled in the art.

Because a user manually moves the printer across the paper and controls the motion of the device, errors in alignment can occur. For best results, the user should begin by aligning the printer parallel to the edge of the paper, and then continue to move the printer such that it remains precisely parallel to the edge of the page. This is needed so that the printed output, such as a page border, remains a constant distance from the edge of the page. Any deviation from parallelism will create misaligned output.

### SUMMARY

Embodiments of the present invention enable users of a handheld printing device to use light guides to assist in aligning the device with a reference, such as the edge of a page. Accordingly, it is a first aspect of one or more embodiments of the present invention to provide a handheld printing device including: a printer housing sized and shaped to be held and guided along a substrate by a human hand; and at least one light guide provided with the printer housing, the light guide being adapted to emit a beam of light that is reflected by the substrate; where the reflection of the beam of light by the substrate creates an illuminated visible straight line segment on the substrate; and where a user can guide the printer housing on the substrate by aligning the visible straight line segment to a reference. In a detailed embodiment, the handheld printing device further includes: a light source; a lens placed in front of the light source; and an opaque shield enclosing the light source and having an opening through which light from the light source can reach the lens; where the lens directs light from the light source to the visible straight line segment on the substrate. In various further detailed embodiments, the light source can be a light-emitting diode, an incandescent bulb, or a laser. The lens can be a divergent lens, which can be divergent along a single axis, such that it creates a straight line segment image of a point source.

In alternative embodiments, the handheld printing device further comprises a plurality of light guides provided with the printer housing, each of the plurality of light guides being adapted to emit a beam of light that is reflected by the substrate. Several light guides can share a common light source. In another embodiment, the handheld printing device has four light guides located at 90-degree intervals around the perimeter of the printer housing; and each of the four light guides emits a beam of light along a line that extends radially from a common point. In another embodiment, the handheld printing device has four light guides; a first and second of the light guides emit beams of light in opposite directions along a first line; a third and fourth of the light guides emit beams of light in opposite directions along a second line; and the first and second lines are parallel. In still another embodiment, at least one of the plurality of light guides is adapted to be manually relocated on the printer housing by a user.

Additional embodiments provide a method of aligning a handheld printing device on a substrate, including: placing the handheld printing device on a substrate; activating one or more light guides on the handheld printing device that emit a beam of light such that an illuminated visible straight line segment is projected onto the substrate; and guiding the handheld printing device on the substrate by aligning the visible straight line segment to a reference. In various detailed embodiments, the reference can be an edge of the substrate or a mark printed on the substrate, which can be images previously printed by the handheld printing device.

In some embodiments, the above-described method further includes: the light guide emitting a beam of light of a first color when the handheld printing device is printing; and the light guide emitting a beam of light of a second color when the handheld printing device is not printing.

In another embodiment, the method further includes: measuring the reflectivity of the surface beneath the handheld printing device to determine if the surface is the substrate; and the light guide turning off the beam of light when the handheld printing device has reached an edge of the substrate.

These and other aspects and embodiments will be apparent from the following description, the accompanying drawings, and the appended claims.

### BRIEF DESCRIPTION OF THE DRAWINGS

FIG. 1 shows a handheld printing device that uses guide marks to align a handheld printer during a print operation.

FIG. 2 shows a handheld printing device with light guides, according to an exemplary embodiment of the present invention.

FIG. 3 shows a handheld printing device with light guides improperly aligned (FIG. 3(a)) and properly aligned (FIG. 3(b)) with an edge of a page, according to an exemplary embodiment of the present invention.

FIG. 4 shows a light guide apparatus including a lens to focus the light and create the beam line on the page, according to an exemplary embodiment of the present invention.

### DETAILED DESCRIPTION

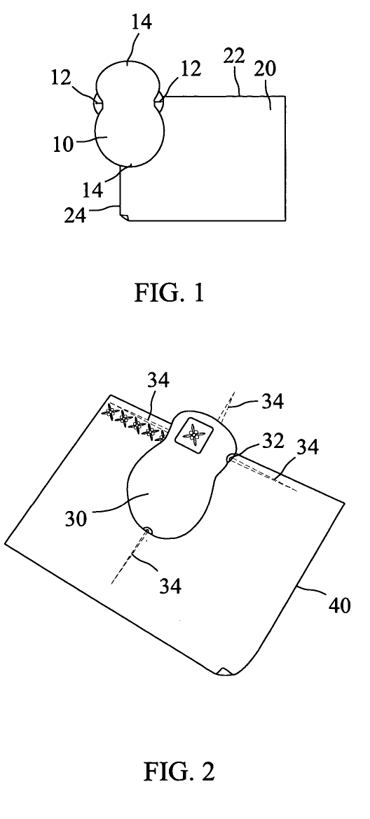

FIG. 1 illustrates one solution to the problem described above of aligning a hand-held printing device as the device is moved across print media. In this illustration, guide marks 12 and 14 are disposed on the side of the printing device 10 and provide a visual indication to the user of the intended print path along the media 20. In practice, the user aligns the guide marks with one or more paper edges 22, 24 (or such other edges that define or otherwise delineate an intended print path) and uses the guide marks to follow the reference edge. An additional (or alternative) solution to this problem is to use wheels on the bottom of the handheld device that help the user maintain a straight line during the print operation.

FIG. 2 illustrates an alternative solution to the problem of aligning a portable or handheld printing device in accordance with an embodiment of the present invention. In this illustration, light guides 32 are used to guide the user's movement. In FIG. 2, a handheld printing device 30 includes light guides 32, each of which projects a straight beam of light 34 onto the page 40. The straight beam of light 34, which is much longer than one of the guide marks discussed above, allows the user to achieve parallelism with the page edge or other reference, such as text or graphics that have been printed on the page. The handheld printing device can be contained in a printer housing that is sized and shaped to be held and guided along a substrate, which can be a page or other medium on which text or graphics can be printed.

The handheld printing device can include a plurality of light sources to allow the user to achieve alignment with references having different orientation or location with respect to the handheld printing device. In the exemplary embodiment shown in FIG. 2, four light guides are included spaced at 90-degree intervals around the perimeter of the handheld printing device. One pair of light guides shines vertically from the handheld printing device in opposite directions, and one pair shines horizontally in opposite directions. This allows the user to achieve simultaneous parallelism with a vertical page edge and a horizontal page edge, regardless of whether the printer is located near the top, bottom, left, or right edge of the page.

The user can engage the light guides in a variety of methods. The light may be on at all times while the device is powered on. Alternatively, users may be required to press a button to activate the lights. Once engaged, the user simply aligns the edge of the page with the beam of light.

Even if one or more edges of the printing device are off the page, the user is still able to achieve alignment before starting to print. The beams of light, which are much longer than the guide marks discussed above, allow parallelism to be determined by observing a single beam in relation to the page edge or other reference. The embodiment featuring four light guides, as shown in FIG. 2, provides an added advantage because one or more beams can be aimed away from the page without loss of ability to guide the device.

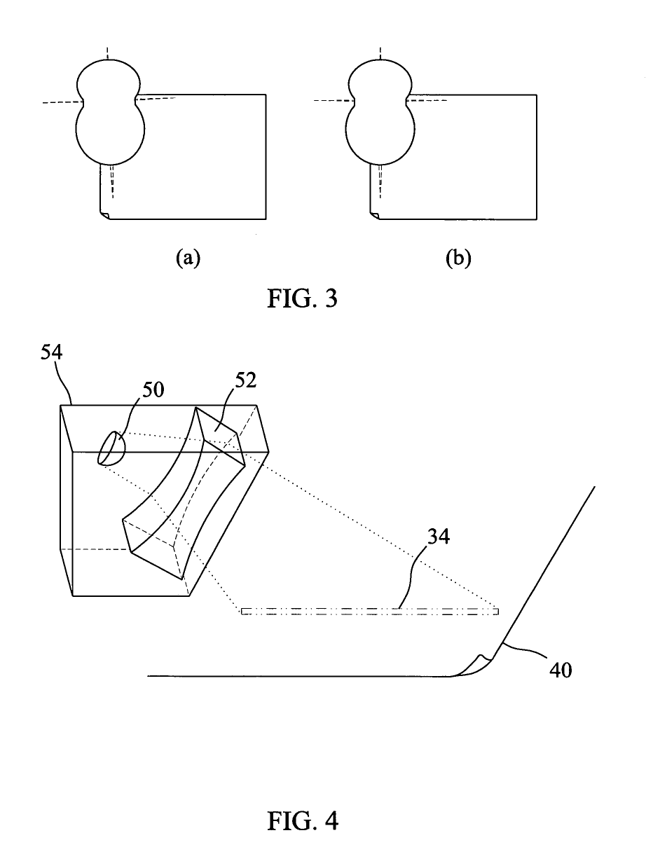

The length of the beam helps the user achieve alignment. FIG. 3(a) shows the printing device in a misaligned starting position. Because the beam of light stretches longer than the guide mark in FIG. 1, it is readily apparent that the device is not aligned parallel to the page edge. The greater length of the light guide's beam takes advantage of the human perceptual system to identify misalignments because the angle between the beam and the page edge is emphasized. There are clearly differing distances from the light beam to the page edge at the beginning of the beam, as compared to the end of the beam. The shape between the light beam and the page edge forms a triangular region as opposed to the needed rectangular region needed to achieve parallelism. In FIG. 3(b), the light beam and the page edge form a rectangular region, indicating that they are parallel and that the handheld printing device is properly aligned.

As an added advantage, the length of the beams allows a portion of the beam to be visible even when the user's hand is positioned over the handheld printing device. Even if wheels help the user keep the device moving in a straight line, they will now have the advantage of the light guides to make sure that the straight line will be parallel to the edge before printing. Finally, no destructive guide marks must be drawn on the page before printing.

There are many ways to implement the light-guides that will be apparent to persons skilled in the art. The exact implementation details will vary depending on the nature of the device, and the constraints placed on it. For example, the light could be created using simple and inexpensive LEDs, or if a significant length of beam was needed (such as to transverse large poster paper) a laser could be used to emit the light. The color of the light is also variable. Certain colors may compliment the aesthetics of the device more than others. The important consideration when selecting color is the contrast with the paper. For example, if the device will be primarily used to print on red paper, selecting red light may not be appropriate. The exact number of lights used is also variable. It is important that a beam is emitted along the axis of movement. For example, if the device is meant to move left/right, then the light should be emitted from the left and right sides of the device.

A single light source inside the device may be sufficient to illuminate multiple light beams. As discussed above, lights can optionally be included perpendicular to the axis of movement (in this example, coming from the top and bottom) of the device. These lights are beneficial to the user because they can be used to help align the device to the perpendicular edge of the page.

FIG. 4 shows an exemplary apparatus including a lens to focus the light and create the beam line on the page. A light source 50 is located behind a divergent lens 52. The lens 52 is concave along one axis, which spreads the light out to form a beam 34. The lens 52 is angled downward so that the beam of light is directed down toward the page 40. An opaque shield 54 encloses the light source 50 and lens 54. The opaque shield 54 and lens 52 are preferably narrow, which helps keep the light traveling in a fixed direction and prevents light spreading wide, thus keeping the beam narrow. In accordance with one embodiment, the emitted light can be between 2-3 mm wide and about 10 cm long.

The shield can also be coated on the inside with a reflective coating to channel more light into the lens. The entire assembly can be mounted inside the handheld printing device at the edge. In an alternative embodiment, the opaque shield 54 can shaped to include a plurality of lenses that are illuminated by a single light source inside the opaque shield. Other suitable arrangements of the light source, lens, reflectors, and opaque shield may be apparent to persons skilled in the art upon reviewing this disclosure.

Additional features can be included in the handheld printing device to assist the user. The light guides 32 can be made to change color when the device is actively printing. The light-guides 32 can be made to change color or turn off when the edge of the paper is detected. This could present a quick visual indicator, preventing the user from printing on the underlying surface (such as a table) instead of on the page. The handheld printing device 30 can include a sensor that measures the reflectivity of the surface below to identify a surface other than paper. Such a sensor can be implemented in ways known to persons skilled in the art.

Alternative arrangements of the light guides can be employed. For example, light guides 32 can be placed along parallel lines coinciding with the top edge and bottom edge of the printed output. For example, if the print-head swath size is 0.5 inches, then there would be a pair of light guides 32 mounted on each side of the handheld printing device, each pair being located 0.5 inches apart. This would help the user visualize exactly where printing will occur on the page.

In another embodiment, the light guides 32 can be made to be relocatably positionable by the user. In such an embodiment, the user can slide the light guides up and down the side (or to the left and right of the top or bottom) of the handheld printing device, thereby allowing the user to align the light guides to any desired reference point. In still another embodiment, the handheld printing device can use a light guide in combination with a level indicator to align the print operation, similar to the laser straight levels that are known in the art and used for hanging pictures and other construction tasks.

Having described the invention with reference to embodiments, it is to be understood that the invention is defined by the claims, and it is not intended that any limitations or elements describing the embodiments set forth herein are to be incorporated into the meanings of the claims unless such limitations or elements are explicitly listed in the claims. Likewise, it is to be understood that it is not necessary to meet any or all of the identified advantages or objects of the invention disclosed herein in order to fall within the scope of any claims, since the invention is defined by the claims and since inherent and/or unforeseen advantages of the present invention may exist even though they may not have been explicitly discussed herein.

What is claimed is:

1. A printing device comprising:
a housing; and
at least one light guide disposed in said housing;
wherein said at least one light guide projects a light that aids in an alignment of said printing device during a print operation.

2. The printing device of claim 1, further comprising:
a light source;
a lens disposed adjacent said light source; and
an opaque shield enclosing said light source and having an opening through which a light from said light source can reach said lens;
wherein said lens directs light from said light source to a visible straight line segment at or near a print media.

3. The printing device of claim 2, wherein said light source is a light-emitting diode.

4. The printing device of claim 2, wherein said light source is an incandescent bulb.

5. The printing device of claim 2, wherein said light source is a laser.

6. The printing device of claim 2, wherein said lens is a divergent lens.

7. The printing device of claim 6, wherein said divergent lens is divergent along a single axis, such that it creates a straight line segment image of a point source.

8. The printing device of claim 2, wherein said opening in the opaque shield has a rectangular shape, and wherein said lens is joined to said opaque shield at an edge of said opaque shield surrounding said opening.

9. The printing device of claim 1, further comprising:
a plurality of light guides disposed in said housing, each of said plurality of light guides being adapted to emit a beam of light.

10. The printing device of claim 9, wherein a first one of said plurality of light guides and a second one of said plurality of light guides have a common light source.

11. The printing device of claim 1, wherein said at least one light guide comprises four light guides located at 90-degree intervals around a perimeter of said housing.

12. The printing device of claim 11, wherein each of said four light guides emits a beam of light that extends radially from a common point.

13. The printing device of claim 1, wherein said at least one light guide comprises four light guides, including first and second light guides that emit beams of light in opposite directions along a first line, and third and fourth light guides that emit beams of light in opposite directions along a second line.

14. The printing device of claim 13, wherein said first and second lines are parallel.

15. The printing device of claim 14, wherein said first and second lines are perpendicular.

16. A method of printing with a manually driven printing, comprising:
placing said printing device on a substrate;
activating one or more light guides disposed on said printing device that emit one or more beams of light such that an illuminated visible straight line segment is projected at or near said substrate; and
using said visible straight line segment to guide a manual movement of said printing device as part of a print operation.

17. A handheld printing device, comprising:
a housing;
a printhead;
a print engine disposed in said housing that requires that said printhead be manually moved across a print media during a print operation;
a guide disposed on said housing that provides a visual indication of a direction of movement during said print operation.

18. The handheld printing device of claim 17, wherein said guide comprises one or more guide marks.

19. The handheld printing device of claim 17, wherein said guide comprises one or more light guides.

20. The handheld printing device of claim 19, wherein said one or more light guides are adapted to emit a beam of light of a first color when said handheld printing device is printing, and to emit a beam of light of a second color when said handheld device is not printing.
